(19) United States
(12) Patent Application Publication
(10) Pub. No.: US 2005/0154856 A1
(43) Pub. Date: Jul. 14, 2005

(54) Method and apparatus for high speed addressing of memory locations within the same page

(76) Inventor: Atousa Soroushi, North Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/758,432

(22) Filed: Jan. 14, 2004

(51) Int. Cl. G06F 12/00

(52) U.S. Cl. 711/218; 711/154

(57) ABSTRACT

A method and apparatus for high speed addressing of memory locations within the same page. Generally, a first selected location in the memory space is accessed using at least a first and second part of the address. Then, a first part of the address of a second selected location in the memory space is transmitted. The method and apparatus determine whether at least a second part of the address of the second selected location corresponding to the second part of the address of the first selected location is the same as the second part of the address of the first selected location, and determines the address for the second selected location without transmitting the second part of the address of the second selected location by joining the second part of the address of the first selected location with the first part of the address of the second location on the condition that the second part of the address of the second selected location is the same as the second part of the address of the first selected location.

The present invention relates to a method and apparatus for high speed addressing of a memory space from a relatively small address space.

### BACKGROUND OF THE INVENTION

An M bit data bus defines an address space of 2^{M} for use in directly addressing a memory or any memory mapped I/O device such as a printer or display (hereinafter “memory device”) coupled to the bus. For example, a typical 8 bit data bus can be used to directly address 2⁸ or 256 locations or addresses in the memory device. Most memory devices, however, have a much greater capacity or memory space. For example, N=16 bits of address are required to access any location within a memory space of 2¹⁶ or 65,536 (“64K”). Accordingly, a 16 bit bus would be required to directly address a 64K memory device.

The M bit bus has been used to indirectly address the N bit memory space in the memory device (i.e., M=8 bits and N=16 bits) by first transmitting M bits of address over the bus sufficient for addressing a first register, and then transmitting M bits of data defining one byte over the bus to be stored in the first register. Then, another M bits of address are transmitted over the bus sufficient for addressing a second register, followed by the transmission over the bus of another M bits of data defining another byte. For all practical purposes, the first and second registers could be combined into one register. The memory device is adapted to join together, or concatenate, the address bytes stored in the first and second registers to form a complete N bit address for addressing a memory location in the memory device.

The multiple address bytes for a given address are transmitted while an “Address Enable” signal is active. Within this time, a “Write Enable” signal goes active for writing address bits, and then goes inactive, and then goes active again for writing a byte of data, and then goes inactive, etc., the transitions of the Write Enable in conjunction with the Address Enable signal defining an “address cycle.” Accordingly, a number of “address cycles” are generally required to write the entire address to the memory. After all of the required address cycles are concluded, the Address Enable signal goes inactive and the Read Enable and Write Enable signals are used to read data from or write data to the addressed location in the memory, defining a Read/Write (or data) cycle.

For example, a CPU can transmit a 16 bit address to a memory using an 8 bit data bus by first transmitting an upper (or lower) 8 bits of the address to the memory during a first and second address cycles, and then transmitting a lower (or upper) 8 bits of the address during third and fourth address cycles. Then, after the four address cycles are concluded, the CPU either writes data to or reads data from the addressed location in the memory during a Read/Write cycle.

In general, additional address cycles are required to address memory spaces that exceed the address space provided by the data bus of the CPU by greater amounts. For each new address, all of the aforementioned steps must be repeated. These constraints undesirably limit the speed of communications between the CPU and the memory. Accordingly, there is a need for a method and apparatus for high speed addressing of memory locations within the same page providing for increased speed of communications with a memory device than has been available in the prior art.

### SUMMARY OF THE INVENTION

A method and apparatus for high speed addressing of memory locations within the same page according to the invention generally accesses a first selected location in the memory space using at least a first and second part of the address of the selected location. Then, a first part of the address of a second selected location in the memory space is transmitted. The method and apparatus determines whether at least a second part of the address of the second selected location corresponding to the second part of the address of the first selected location is the same as the stored second part of the address of the first selected location, and determines the address for the second selected location without transmitting the second part of the address of the second selected location by joining the stored second part of the address of the first selected location with the first part of the address of the second location on the condition that the second part of the address of the second selected location is the same as the second part of the address of the first selected location. Preferably, the method and apparatus provide an Address Enable signal that is active during at least part of the time during which the first part of the address of the second selected location is transmitted.

### BRIEF DESCRIPTION OF THE DRAWINGS

FIG. 1 is a schematic view of a prior art apparatus for addressing a memory space from a relatively small address space.

FIG. 2 is a schematic view of an apparatus for high speed addressing of a memory space from a relatively small address space according to the present invention.

FIG. 3 is a timing diagram illustrating operation of the apparatus of FIG. 2.

FIG. 4 is a time progression schematic view of indirect addressing registers being provided with address data according to the present invention.

FIG. 5 is a time progression schematic view of the indirect addressing registers of FIG. 4 being provided with address data according to another embodiment of the present invention.

### DETAILED DESCRIPTION OF A PREFERRED EMBODIMENT

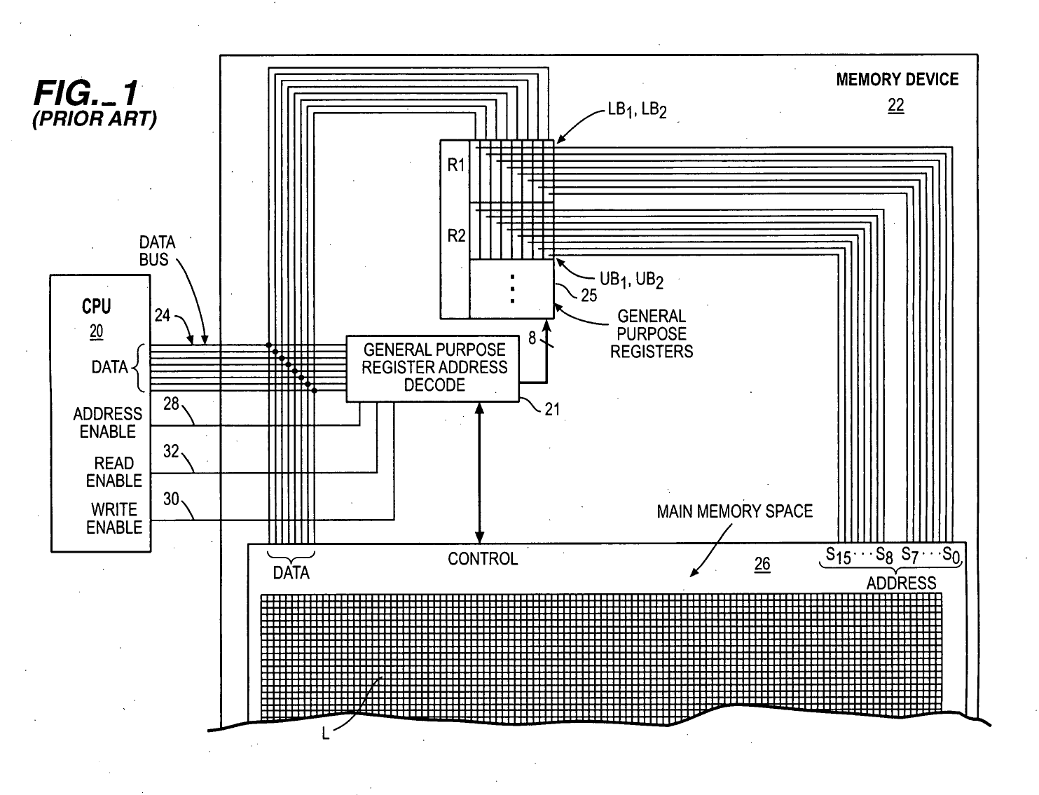

A preferred context of the present invention is described with reference to FIG. 1, representing a prior art methodology for interfacing a CPU 20 and a memory device 22, such as may be used in a graphics display system for example. The memory device 22 includes a plurality of general purpose registers 25 and a general purpose register address decode circuit 21. To provide cost savings, the CPU in this example employs an 8 bit data bus 24 that is also used as an address bus. The memory device, however, typically has an address space (indicated as MAIN MEMORY SPACE 26) that requires at least 16 bits of address. Accordingly, the memory device must be indirectly addressed and general purpose registers R1 and R2 in the memory device are used to store an 8 bit lower byte (LB) and an 8 bit upper byte (UB) respectively that are transmitted sequentially from the CPU over the data bus. The memory device is typically accessed asynchronously, i.e., while the CPU typically performs operations in periodic clock cycles, the timing of operations on the memory device generally does not have a periodic or defined relationship to the clock.

The general purpose register address decode circuit 21 monitors control signals on lines 28, 30, and 32 as well as data signals on the bus 24. In response to control and data signals, the general purpose register address decode circuit 21 may store bits on the bus in registers 25, provide control signals to the main memory space 26, or perform other functions.

In this example, the CPU asserts the “Address Enable” and “Write Enable” lines, 28 and 30, and places the 8 bits (or fewer) defining the address of the register R1 on the data bus, defining a first address cycle. The Write Enable line 30 is de-asserted and then reasserted, defining a second address cycle, as the CPU places 8 bits of data defining a lower byte LB₁ of the desired 16 bit address, corresponding to a location L in the main memory space, on the data bus. Next, the Write Enable line is again de-asserted and then reasserted as the CPU places the 8 bits defining the address of the register R2 on the data bus, defining a third address cycle. Finally, the Write Enable line is yet again de-asserted and then reasserted as the CPU places 8 bits of data defining an upper byte UB₁ of the desired 16 bit address on the data bus, defining a fourth address cycle.

The memory device is adapted to join together or concatenate the upper byte UB and the lower byte LB to provide a 16 bit address in this example. The complete 16 bit address may now be used by the memory device to access the location L. The “Address Enable” line is then de-asserted to initiate a Read/Write cycle. If a Read cycle is desired, a Read Enable line 32 is activated and the contents of the location L are output by the memory device onto the data bus. If a Write cycle is desired, the CPU outputs data on the data bus for writing to the location L and a Write Enable line is activated to place the contents of the data bus in the location L.

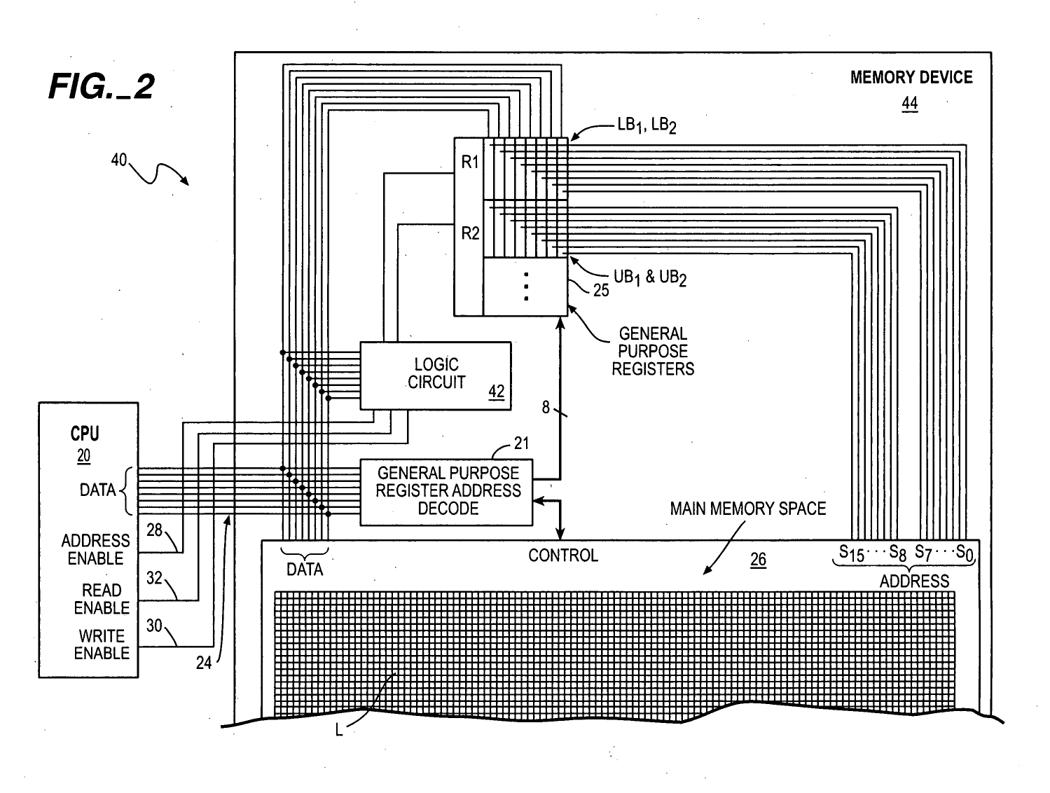

Turning now to FIG. 2, an apparatus 40 for high speed addressing of memory locations within the same page according to the present invention is shown. The apparatus 40 includes a logic circuit 42 that alters the operation described above. More particularly, the registers R1 and R2 are under the control of the logic circuit 42.

Registers R1 and R2 may be initially provided according to the invention with a lower byte LB and an upper byte UB as in the prior art, consuming four address cycles in the example given. However, preferably, the logic circuit 42 provides in addition a high speed mode of operation for standard indirect addressing, referred to herein as “high speed standard mode.”

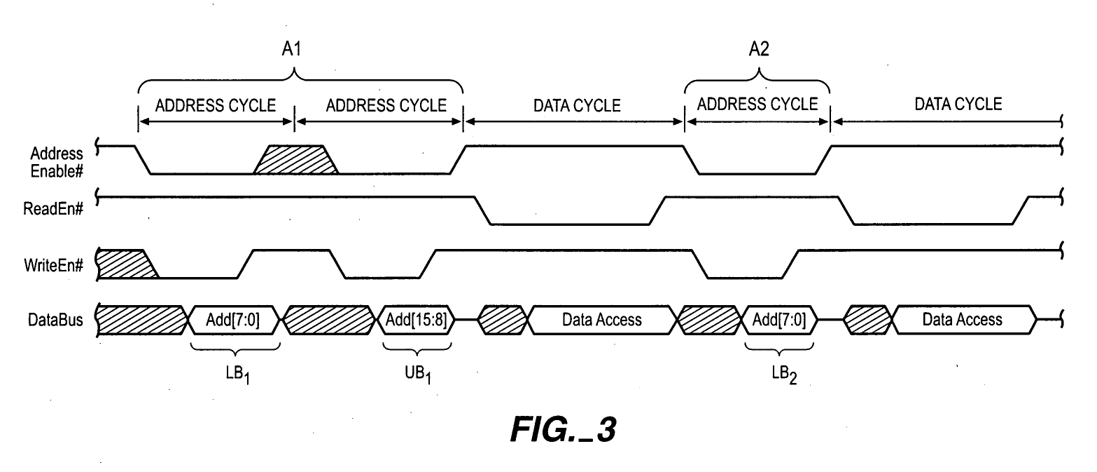

FIG. 3 is a timing diagram illustrating the operation of the apparatus 40 for addressing a memory device in high speed standard mode according to the present invention. Particularly, for comparison with the example above, the address cycles corresponding to writing the address of the registers R1 and R2 are eliminated in high speed standard mode. Rather, according to the invention, the CPU asserts the “Address Enable” and “Write Enable” lines and places the 8 bits of data defining a lower byte LB₁ of a desired 16 bit address A1 (see FIG. 3), corresponding to the location L in the main memory space, on the data bus. This defines a first address cycle. Next, the Write Enable line is again de-asserted and then reasserted as the CPU places 8 bits of data defining an upper byte UB₁ of the address A1 on the data bus, defining a second and final address cycle.

As in the prior art, the memory device is adapted to join together or concatenate the upper byte UB₁ and the lower byte LB₁ to provide the complete address A1, which may now be used by the memory device to access the location L.

To provide for high speed standard mode, the logic circuit 42 includes hardware or software that recognizes assertion of the Address Enable and Write Enable lines, and automatically addresses registers R1 and R2 sequentially for storing respective data bytes that are placed sequentially on the bus.

Regardless of how the first and second registers are provided with address data, the invention provides an enhanced high speed mode (“high speed enhanced mode”) for subsequent addressing under certain conditions. Particularly, after accessing the location L defined by the address A1, the CPU transmits a second address A2 (see FIG. 3) to the memory device. However, if the upper byte UB₂ of the second address is equal to the upper byte UB₁ (shown as UB_{1&2}) of the first address A1, there is no need to transmit the byte UB₂. According to the invention, the CPU (or software running on the CPU) recognizes that it need only transmit the lower byte LB₂, thereby saving an address cycle.

The logic circuit 42 is adapted to receive the Write Enable, Read Enable, and Address Enable signals. If UB₂ is equal to UB₁, the CPU de-asserts the Address Enable line (rather than keeping it asserted in anticipation of transmitting the upper byte UB₂ of the address A2). When the logic circuit 42 detects that the CPU de-asserts the Address Enable line after the lower byte LB₂ of the address A2 is transmitted, and asserts a Read Enable or Write Enable while Address Enable is de-asserted, the logic circuit 42 takes this as an indication that the CPU (or software running on the CPU) has determined that UB₂ is equal to UB₁. The logic circuit 42 advantageously recognizes this determination by the CPU without the need for providing an additional line between the CPU and the memory device. A timing diagram describing this operation is shown in FIG. 3.

In particular, the logic circuit 42 is adapted to determine whether the condition: UB₂ is equal to UB₁ is true. The logic circuit 42 determines whether the condition is true based on the indications it receives from the CPU. The CPU provides this indication by de-asserting the Address Enable line after the lower byte LB₂ of the address A2 is transmitted, and asserting a Read Enable or Write Enable while Address Enable is de-asserted for a following read or write cycle.

If the logic circuit 42 determines that the condition described above is true and the upper byte UB₂ of the address A2 will not be transmitted by CPU, i.e., the address A2 is on the “same page” in memory as the address A1, the circuit 42 does not wait to obtain a new upper byte, and instead begins immediately to join together or concatenate the lower byte LB₂ and the upper byte UB₁ to produce the address A2.

The timing diagram of FIG. 3 defines the logic used by the logic circuit C for determining that the CPU does not intend to send an upper byte UB₂ for a second address A2. For normal operation, that is, where two bytes of address are transmitted, the Address Enable signal is asserted and the Read Enable signal is de-asserted. The Write Enable signal transitions from being asserted to being de-asserted during transmission of the first byte, and transitions again in the same manner during transmission of the second byte.

For operation in high speed enhanced mode according to the invention, where an upper byte is already present in the register R2 of FIG. 2, a first byte is transmitted normally, as described above. However, the first byte will be understood to be the last byte when, subsequently, the CPU de-asserts the Address Enable signal and asserts either the Read Enable or Write Enable signal, indicating a Read or Write Data cycle, for reading to or writing from a memory location. Various ways of implementing this logic, either in hardware or in software, will be readily apparent to persons of ordinary skill.

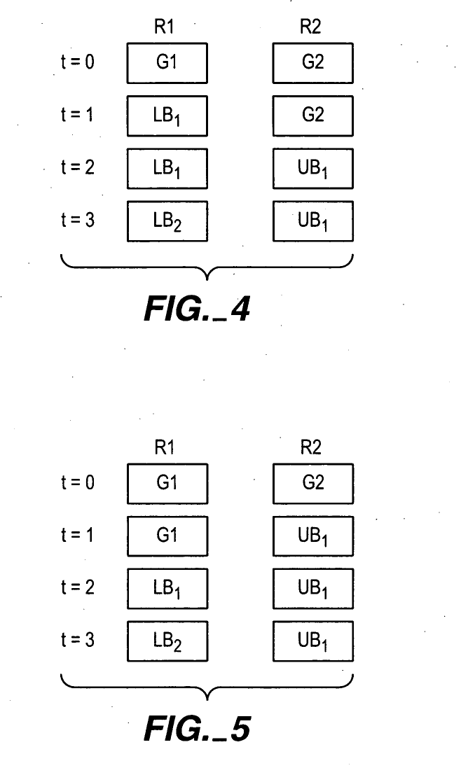

It should be noted that the examples provided above are adapted for transmitting the lower byte first, and then the upper byte. The reverse could be implemented as well, where FIGS. 4 and 5 show schematically the operation of the logic circuit 42 for the respective implementations.

Particularly, with reference to FIG. 4, time t=0 represents an initial state of the registers R1 and R2, where register R1 contains arbitrary data G1 and R2 contains arbitrary data G2. At a subsequent time t=1, a lower byte LB₁ over-writes G1 in register R1. At a later time t=2, an upper byte UB₁ over-writes G2 in register R2. At a still later time t=3, a new lower byte LB₂ over-writes LB₁ in register R1. Finally, the logic circuit C proceeds in high speed enhanced mode, based on the state defined by the Address Enable, Read Enable and Write Enable signals after receipt of the lower byte LB₂, to send the address defined by the two registers to the Control section (FIGS. 1 and 2) of the memory device, for addressing the location L.

Alternatively, with reference to FIG. 5, at time t=1 an upper byte UB₁ over-writes G2 in register R2, at time t=2 a lower byte LB₁ over-writes G1 in register R1, and at time t=3, the next byte is stored in register R1 as LB₂, over-writing LB₁.

It should be understood that the use of 8 bit bytes in the examples provided is arbitrary. It should also be noted that, while in the preferred embodiment of the invention the entire upper byte defines a “page,” a page may be defined with a fewer or a greater number of bits with suitable modification to the logic circuit 42.

It is further to be recognized that, while a specific method and apparatus for high speed addressing of a memory space from a relatively small address space has been shown and described as preferred, other configurations and methods could be utilized, in addition to those already mentioned, without departing from the principles of the invention.

The terms and expressions which have been employed in the foregoing specification are used therein as terms of description and not of limitation, and there is no intention in the use of such terms and expressions to exclude equivalents of the features shown and described or portions thereof, it being recognized that the scope of the invention is defined and limited only by the claims that follow.

1. A method for high speed addressing of memory locations within the same page by accessing a first selected location in the memory space using at least a first and a second part of the address of the selected location, the method comprising the steps of:
(a) transmitting a first part of the address of a second selected location in the memory space;
(b) determining whether at least a second part of the address of said second selected location corresponding to the second part of the address of the first selected location is the same as the second part of the address of the first selected location; and
(c) determining the address for said second selected location without transmitting said second part of the address of said second selected location by joining the second part of the address of the first selected location with said first part of the address of said second location on the condition that said second part of the address of said second selected location is the same as the said second part of the address of the first selected location as determined in step (b).

2. The method of claim 1, further comprising storing the second part of the address of the first selected location in a register in the memory.

3. The method of claim 2, further comprising providing an Address Enable signal that is active during at least part of step (a), wherein step (b) includes determining whether said Address Enable signal is inactive.

4. The method of claim 1, wherein said first and second parts of the address of the first and said second selected location are of equal size.

5. The method of claim 2, wherein said first and second parts of the address of the first and said second selected location are of equal size.

6. The method of claim 3, said first and second parts of the address of the first and said second selected location are of equal size.

7. An apparatus for high speed addressing of a memory locations within the same page by accessing a first selected location in the memory space using at least a first and a second part of the address of the selected location, the apparatus comprising a logic circuit adapted to perform a method comprising the steps of:
(a) transmitting a first part of the address of a second selected location in the memory space;
(b) determining whether at least a second part of the address of said second selected location corresponding to the second part of the address of the first selected location is the same as the second part of the address of the first selected location; and
(c) determining the address for said second selected location without transmitting said second part of the address of said second selected location by joining the second part of the address of the first selected location with said first part of the address of said second location on the condition that said second part of the address of said second selected location is the same as the said second part of the address of the first selected location as determined in step (b).

8. The apparatus of claim 7 adapted to store the second part of the address of the first selected location in a register in the memory.

9. The apparatus of claim 8, wherein said logic circuit is further adapted to receive an Address Enable signal that is active during at least part of step (a), wherein said logic circuit is further adapted so that step (b) includes determining whether said Address Enable signal is inactive.

10. The apparatus of claim 7 adapted so that said first and second parts of the address of the first and said second selected location are of equal size.

11. The apparatus of claim 8 adapted so that said first and second parts of the address of the first and said second selected location are of equal size.

12. The apparatus of claim 9 adapted so that said first and second parts of the address of the first and said second selected location are of equal size.

13. A machine readable medium embodying a program of instructions for execution by a machine to perform a method for high speed addressing of memory locations within the same page by accessing a first selected location in the memory space using at least a first and a second part of the address of the selected location, the method comprising the steps of:
(a) transmitting a first part of the address of a second selected location in the memory space;
(b) determining whether at least a second part of the address of said second selected location corresponding to the second part of the address of the first selected location is the same as the second part of the address of the first selected location; and
(c) determining the address for said second selected location without transmitting said second part of the address of said second selected location by joining the second part of the address of the first selected location with said first part of the address of said second location on the condition that said second part of the address of said second selected location is the same as the said second part of the address of the first selected location as determined in step (b).

14. The machine readable medium of claim 13 adapted so that the method further comprising storing the second part of the address of the first selected location in a register in the memory.

15. The machine readable medium of claim 14 adapted so that the method further comprises providing an Address Enable signal that is active during at least part of step (a), wherein step (b) includes determining whether said Address Enable signal is inactive.

16. The machine readable medium of claim 13 adapted so that said first and second parts of the address of the first and said second selected location are of equal size.

17. The machine readable medium of claim 14 adapted so that said first and second parts of the address of the first and said second selected location are of equal size.

18. The machine readable medium of claim 15 adapted so that said first and second parts of the address of the first and said second selected location are of equal size.

19. The machine readable medium of claim 16 adapted so that said first and second parts of the address of the first and second selected locations are each 8 bits.

20. The machine readable medium of claim 18 adapted so that said first and second parts of the address of the first and second selected locations are each 8 bits.
